(19) United States
(12) Patent Application Publication
(10) Pub. No.: US 2025/0143840 A1
(43) Pub. Date: May 8, 2025

(54) ORTHODONTIC APPLIANCES, SYSTEMS FOR MANUFACTURING ORTHODONTIC APPLIANCES, AND METHODS OF MANUFACTURING ORTHODONTIC APPLIANCES UTILIZING THOSE SYSTEMS

(71) Applicant: Ormco Corporation (Spark/Aligner Division), Brea, CA (US)

(72) Inventors: Claire Livengood, Brea, CA (US); Evan Yifeng Tsai, Rancho Cucamonga, CA (US)

(21) Appl. No.: 18/503,562

(22) Filed: Nov. 7, 2023

(51) Int. Cl. A61C 7/00; A61C 7/08; A61C 13/00

(52) U.S. Cl. CPC A61C 7/002; A61C 7/08; A61C 13/0019

(57) ABSTRACT

Orthodontic appliances including dental aligners for orthodontic treatment. A system for manufacturing an orthodontic appliance includes a mold having a base and projections. The base and the projections are made of a resin configured to react with a fluid, such as water. The system further includes a fluid bath configured to receive the mold. A method of manufacturing an appliance includes providing a mold including projections representing teeth. The mold is made of a resin. The method further includes deforming a worksheet over the projections and exposing the resin to a fluid. At least one material property of the resin changes. During or afterwards, the appliance is removed from the mold. Removing the appliance may include self-removal. During exposing, the change in property includes a change in volume of the mold. Exposing the resin to the fluid includes submerging the mold in the fluid. The fluid may be liquid water.

### BACKGROUND

Orthodontics is the practice of manipulating teeth to correct malocclusions between the teeth of the upper and lower dental arches. Typically, treatment of malocclusions includes the use of an orthodontic appliance that applies corrective forces to the teeth. Over time, these corrective forces coerce the teeth to move into their orthodontically correct positions.

One way of applying corrective forces is with orthodontic appliances referred to as “dental aligners,” or simply “aligners.” Aligners are supplied as a series of removable appliances that incrementally reposition the patient's teeth from their initial orientation to their orthodontically correct orientation. Patients being treated with aligners can insert and remove the aligners at will. When one aligner has moved the teeth to at or near a final orientation for that aligner, the patient merely begins using the next aligner in the series according to a treatment plan, which is prescribed by a clinician.

To fabricate aligners, the clinician first obtains a computer model of the patient's dentition. This model may be generated from data by taking an impression of the dentition and scanning the impression into a computer. Alternatively, the data may be generated by directly scanning the patient's teeth with an intraoral scanner. In either case, the scanned data is then used to construct the computer model of the patient's dentition.

Once the computer model has been obtained, the orthodontist may manipulate individual teeth in the computer model to determine a final orientation of each tooth that provides a corrected dentition. Multiple computer models may then be generated, with each model corresponding to an incremental orientation of the dentition from an initial orientation to a target orientation. The incremental orientations from initial to target orientations may be designed to move the patient's teeth according to a treatment plan. Treatment plans typically include numerous stages of movement from an initial orientation to a target orientation. Depending on the degree of tooth movement, treatment plans may include a series of aligners that are worn in a predetermined sequence to move teeth from the initial orientation to the target orientation with the last aligner moving the patient's teeth to the final orientation.

Once the design of the series of aligners is complete, the series of aligners is fabricated. Manufacturing each aligner in the series typically first involves manufacturing a series of molds. Each mold in the series corresponds to the patient's teeth in a targeted orientation according to the computer models. From each mold, an aligner is formed. This includes deforming a plastic sheet over the mold constructed of a target orientation of the dentition. After forming, waste material must be trimmed away to produce the aligner. Trimming may utilize CNC milling or another computer controlled cutting system.

Certain types of malocclusions may require use of specialized structures at one or more periods during orthodontic treatment. These structures, such as attachments, may be secured to the patient's teeth for a predetermined period of time and then removed. Specialized structures permit more efficient application of tooth moving forces during orthodontic treatment. Conventionally, these structures are made of composites that are bonded to the teeth (e.g, molars) using a template. This process results in a solid object being adhesively secured to an occlusal surface of a patient's tooth, one that is not removable by the patient. Aligners are designed to cooperate with these structures to enhance orthodontic treatment.

In that regard, one or more aligners may include integral structures, such as a receptacle to receive an attachment secured to a tooth. Other integral structures include bite ramps and integral hooks. Integral structures in aligners can present problems during manufacturing. For example, integral structures typically require a corresponding structural feature to be placed on the mold from which the aligner is formed. Adding the structural feature makes the mold more complex and consequently more difficult to manufacture. Further, structural features that project outwardly from the mold can create difficulties in properly forming the integral structure in the aligner during thermoforming. Even if properly formed, separating the as-formed aligner from the mold can be problematic. Other problems that may occur during separation include breakage of the structural feature. The broken feature may become lodged in or remain attached to the aligner in which case both the as-formed aligner and the mold may become unusable.

While generally successful, there remain problems with manufacturing aligners. What is needed are improved manufacturing processes, methods, and systems for manufacturing aligners.

### SUMMARY

The present invention overcomes the foregoing and other shortcomings and drawbacks of methods and systems heretofore known for orthodontic appliance manufacturing. While the invention will be described in connection with certain embodiments, it will be understood that the invention is not limited to these embodiments. On the contrary, the invention includes all alternatives, modifications, and equivalents as may be included within the spirit and scope of the present invention.

In accordance with one aspect of the present invention, a method of manufacturing an orthodontic appliance includes providing a mold including one or more projections representing a patient's teeth. The mold is made of a resin. The method further includes deforming a worksheet over the one or more projections. The deformed worksheet includes the orthodontic appliance. The method further includes exposing the resin to a fluid whereby at least one material property of the resin changes. During or after a change in the at least one material property, the method further includes removing the orthodontic appliance from the mold.

In one embodiment, during exposing, the change in the at least one material property of the resin includes a change in a volume of the mold. In one embodiment, the change in the volume is from a first volume of the mold during deforming of the worksheet to a second volume after exposing the resin to the fluid. For example, the second volume is greater than the first volume. As a further example, the second volume is at least 20% greater than the first volume.

In one embodiment, exposing the resin to the fluid includes submerging the mold and the deformed worksheet in the fluid. In one embodiment, exposing the resin to the fluid includes simultaneously exposing the mold with at least a portion of the deformed worksheet to the fluid. As an example, the fluid is water, and the water may be liquid.

In one embodiment, the fluid is liquid. In one embodiment, the fluid is liquid water and the change in the material property of the resin includes a change in a volume of the mold. As such, according to one embodiment, exposing the resin to the liquid water includes submerging the mold in the liquid water.

In one embodiment, the fluid is liquid water and the change in the material property of the resin includes a change in a weight of the mold from a first weight prior to deforming to a second weight after exposing, the second weight being greater than the first weight.

In one embodiment, providing the mold includes printing the mold.

In one embodiment, during removing, the deformed worksheet self-separates from the mold.

According to one aspect of the invention, there is an orthodontic appliance made according to one embodiment of a method disclosed herein. In one embodiment, the orthodontic appliance is a dental aligner, and the dental aligner includes a hollow shell having at least one cavity configured to receive at least one of a patient's teeth.

According to one aspect of the invention, there is a system for manufacturing an orthodontic appliance. The system includes a mold having a base and one or more projections representing one or more of a patient's teeth extending from the base. The base and the one or more projections are made of a resin configured to react with a fluid whereby at least one material property of the mold changes. In one embodiment, the resin is configured to react with water. In one embodiment, the at least one material property is the volume of the mold. As an example, the volume of the mold is configured to increase by at least 20% when exposed to the fluid. As an example, the resin is configured to swell at a rate of at least 0.96 cc per hour when exposed to the fluid.

In one embodiment, the system further includes a fluid bath configured to receive the mold. In one embodiment, the fluid bath is a water bath.

In one embodiment, the system further includes a printer configured to transform one or more precursors into the mold made of the resin.

### BRIEF DESCRIPTION OF THE DRAWINGS

Embodiments of the present disclosure will now be described hereinafter, by way of example only, with reference to the accompanying drawings in which:

FIG. 1 is a perspective view of a worksheet and a mold corresponding to a model of a patient's teeth prior to deforming the worksheet over the mold according to one embodiment of the invention.

FIG. 2 is a perspective view of the worksheet and the mold of FIG. 1 after the worksheet is deformed over the mold according to one embodiment of the invention.

FIG. 3 is a perspective view of an aligner prior to removal of the aligner from the mold according to one embodiment of the invention.

FIG. 4 is a perspective view of an aligner including an integral structure in accordance with one embodiment of the invention.

FIG. 5 schematically illustrates a mold material which swells when submerged in a fluid according to one embodiment of the invention.

FIG. 6A is a graph of time versus volume of a mold material according to one embodiment of the invention when the mold material is submerged in a fluid.

FIG. 6B is an enlarged view of one area of graph shown in FIG. 6A.

FIG. 7 is a graph of time versus mass of two different mold materials, one mold material according to one embodiment of the invention and a second mold material when the mold materials are submerged in a fluid.

FIG. 8 is a graph of time versus mass of a mold material according to one embodiment of the invention with and without application of ultrasound while submersed in a fluid.

FIG. 9 is a perspective view a deformed worksheet prior to removal from a mold according to one embodiment of the invention.

FIG. 10A is a schematic cross-sectional view taken along section line 10A-10A of FIG. 9 following cutting away of a waste portion of a deformed worksheet along a simulated CNC cut line and prior to separation of the aligner from the mold according to one embodiment of the invention.

FIG. 10B is a cross-sectional view of the mold and aligner of FIG. 10A following swelling of the mold according to one embodiment of the invention.

FIG. 11 depicts separating a deformed worksheet from a mold in the manufacturing of an aligner.

FIG. 12 is a schematic illustration of a system for producing a mold material and a 3-D printer according to certain aspects of the present disclosure.

FIGS. 13A, 13B, and 13C are perspective views of molds having combinations of treatment structures according to one or more embodiments of the invention.

FIGS. 14 and 15 depict separating an aligner from a swollen mold and the aligner separate from the swollen mold, respectively.

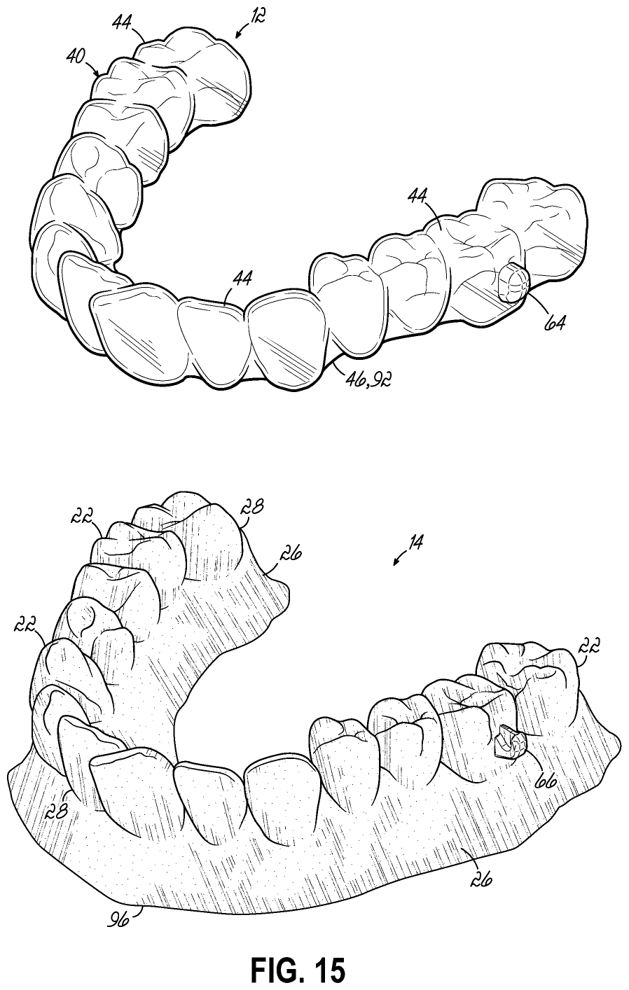

FIG. 16 is a flow chart for manufacturing orthodontic appliances according to one embodiment of the invention.

### DETAILED DESCRIPTION

This disclosure relates generally to systems for orthodontic treatment of a patient, including orthodontic appliances, such as dental aligners, and systems implementing orthodontic appliances, and to methods for manufacturing orthodontic appliances. According to some embodiments, during the manufacturing of the orthodontic appliance, at least one mold with model teeth is manufactured. A worksheet may then be deformed over the mold. During deformation, the worksheet replicates the features of the mold, specifically the features of the model teeth. The mold and the deformed worksheet must be separated from one another. Applicant discovered that mold materials that change properties can facilitate separation of the orthodontic appliance from the mold after deforming the worksheet. In exemplary embodiments of the invention, prior to or during separation, the mold is activated to facilitate separation of the deformed worksheet or the appliance from the mold. As an example, once activated, at least a portion of the mold changes material properties, and the property change eases separation of the mold from the aligner. In one embodiment, the property change causes spontaneous separation of the mold from the orthodontic appliance. Little or no external force is required to separate the mold from the appliance. That is, the mold self-separates from the appliance sometime after being activated. In one embodiment, the mold may not spontaneously separate from the appliance, but activation of the mold causes forces to be generated between the mold and the appliance over time. The net forces may assist in the removal of the appliance from the mold. Further in that regard, the forces generated by the mold on the appliance reduce an external threshold force required to separate the mold from the orthodontic appliance. As a result, the orthodontic appliance and the mold are easier to separate. Advantageously, in embodiments, the mold assists in separation and may reduce the need for external force application. With separation assistance from the mold itself, mold configurations may also be utilized for manufacturing of orthodontic appliances with unique integral features.

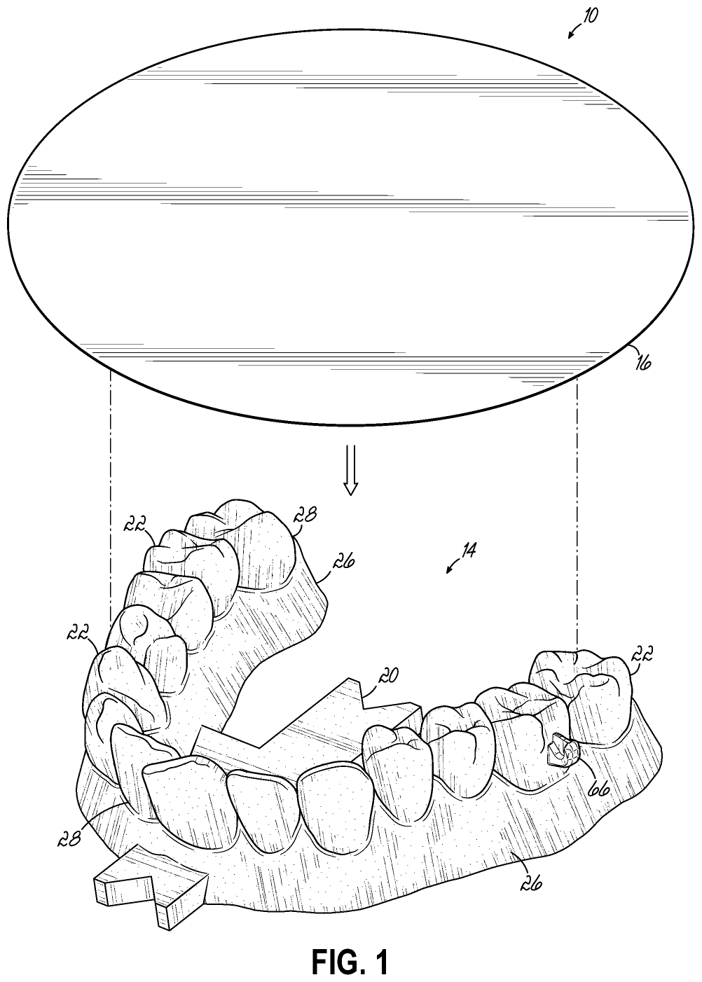

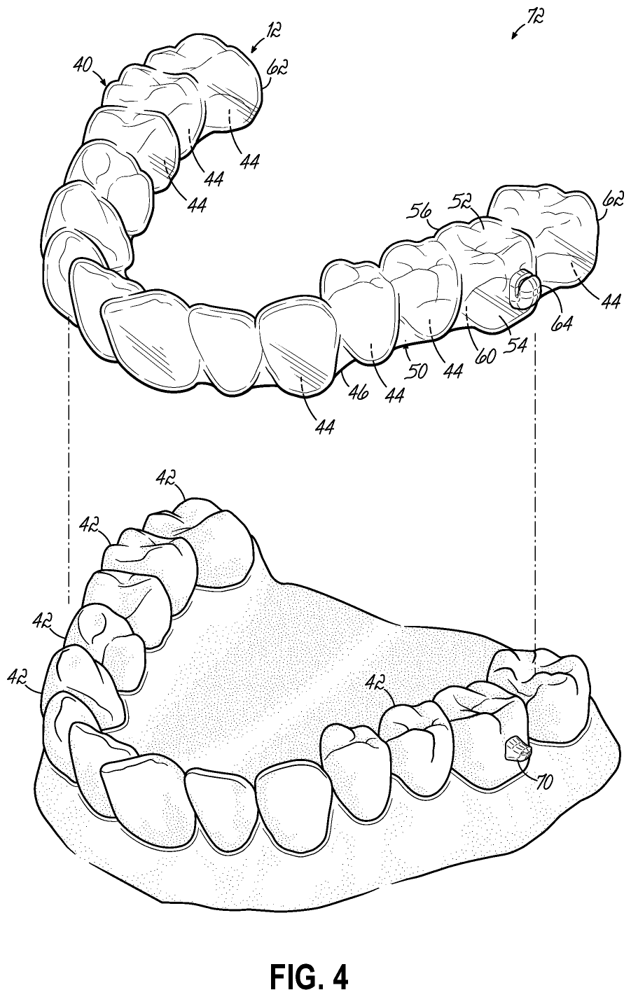

To these and other ends, and referring to FIGS. 1-4, an exemplary system 10 for manufacturing an orthodontic appliance 12 (FIG. 4) includes a mold 14 over which a worksheet 16 is deformed. While the exemplary orthodontic appliance 12 shown is a dental aligner, other orthodontic appliances include retainers and sleep apnea devices, among others. The mold 14 is manufactured of a material that is capable changing properties in such a way to facilitate separation of the aligner 12 from the mold 14. One exemplary material is a resin that reacts with a fluid. As an example, the resin may absorb water into its molecular structure. As it does, the molecular structure expands, much like a sponge. Volumetric expansion may be referred to herein as swelling and refers to the capability of the mold material to absorb a fluid, and in doing so, the mold increases along one or more dimensions and/or changes shape. In this exemplary embodiment, the mold 14 has a dual purpose. First, it forms a base over which the worksheet 16 is deformed. Second, after deforming the worksheet 16, the mold is capable of assisting in the separation of itself from the deformed worksheet. Material property modification may be selectively initiated by an activation process.

In the exemplary embodiment, in a method of manufacturing of the aligner 12, activation of the mold 14 is initiated after deforming the worksheet 16. While described in detail below, one exemplary activation process is to submerge the mold 14 and deformed worksheet in a fluid. The fluid and the material of the mold 14 interact to produce a change in properties of the mold 14. In one exemplary embodiment, the fluid and the material of the mold 14 may react. As an example of one reaction, the mold 14 swells when exposed to the fluid. This may be observed by an increase in the volume of the mold 14 following activation. Thus, in one embodiment, manufacturing the aligner 12 includes submerging the mold 14 in a fluid following deforming the worksheet 16 and while the deformed worksheet remains coupled to the mold 14. Once submerged, the mold 14 swells thereby pushing the aligner 12 off the swelling mold. Changes to the material properties of the mold may include one or more of a change in volume, a change in weight, a change in the hardness, and a change in the elasticity. In the exemplary embodiment, the aligner 12 is inert to the fluid. So, while activating the mold 14 produces a material property change in the mold 14, activation does not produce a material change in deformed worksheet or aligner 12.

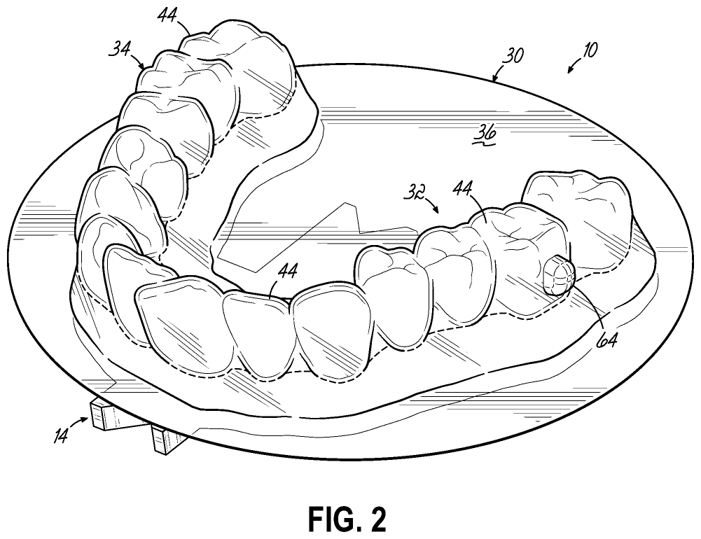

More specifically and with reference to FIGS. 1 and 2, the mold 14 includes a base 20 and a plurality of projections 22 extending away from the base 20. As shown, the projections 22 may extend from a model gingiva 26 and provide a gingival margin 28. Each of the projections 22 may be a replica of one of the patient's teeth. The position and orientation of each projection 22 extending from the model gingiva 26 may be determined via a computer model generated from an orthodontic treatment plan. The computer model is based on the patient's initial dentition. By way of example, the orthodontist may obtain an impression of the patient's dentition using a suitable impression material. This impression may then be scanned into a computer using a three-dimensional scanning device to generate a three-dimensional computer model of the patient's initial dentition. The three-dimensional scanning device may alternatively be used to obtain the computer model by directly scanning the patient's dentition.

The computer model of the initial dentition may be used by the orthodontist as a starting point to generate a target dentition model and one or more intermediate digital dentition models. The target digital dentition model may represent a desired positioning of the patient's teeth at the conclusion of orthodontic treatment. Thus, during an orthodontic treatment planning process, a series of computer models that provides incremental steps from the initial dentition to the one or more intermediate dentition models and ending with the target dentition is generated. Once the computer dentition models have been generated, one or more molds 14 may be fabricated from the virtual dentition models using additive manufacturing (e.g., a 3-D manufacturing technique), CNC machining, a combination of these, or any other suitable method. Thus, the molds 14 are physical representations of the digital dentition models in one or more of the initial, intermediate, and target teeth orientations per the computer model.

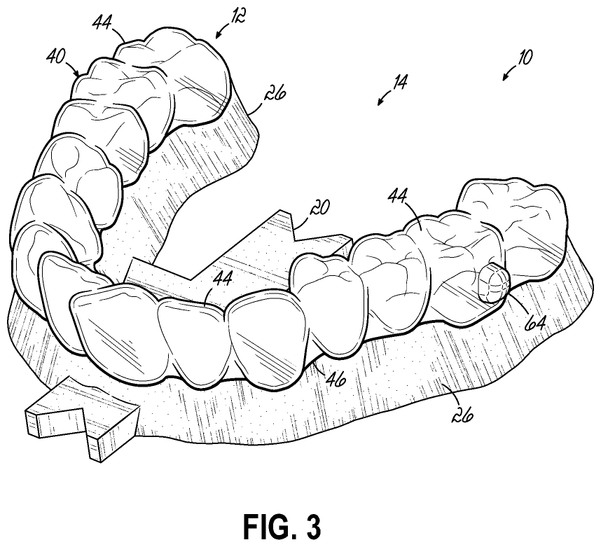

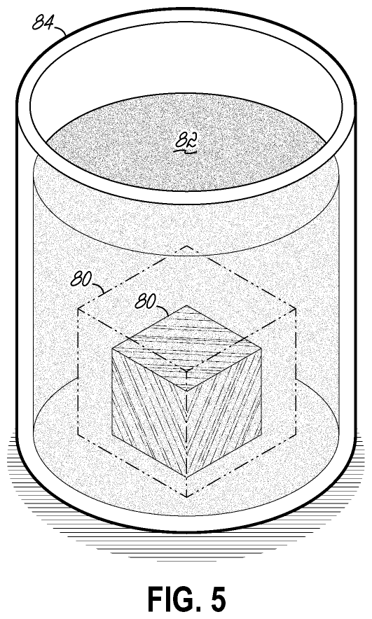

During manufacturing of the aligner 12, and with reference to FIGS. 2 and 3, the worksheet 16 is deformed over the mold 14. By way of example only, the worksheet 16 may be thermoformed over the mold 14. Following deforming, a deformed worksheet 30 includes a deformed region 32. The deformed region 32 includes an aligner portion 34. The deformed worksheet 30 may also include a waste portion 36. With reference to FIG. 3, when present, the waste portion 36 is removed, such as by machining or manually, leaving the aligner 12 coupled to the mold 14, as shown in FIG. 3. The aligner 12 is then separated from the mold 14. Separation is described more fully with reference to at least FIGS. 5, 6A, 6B, 7, 8, 9, 10B, and 11B below.

After separation, and with reference to FIG. 4, with or without further processing, the dental aligner 12 may be further prepared for use by the patient. As shown, the aligner 12 includes a hollow shell 40 that is configured to encapsulate one or more crowns 42 of a patient's teeth during orthodontic treatment. The shell 40 may be an elastic material in one or more layers and is formed with a plurality of cavities 44 that collectively define an edge 46. By way of example, the material of the shell 40 may be TruGEN or TruGEN XR, which are copolyesters, as is available in the Spark™ clear aligner from Ormco Corporation, Brea, California. The edge 46 defines an opening 50 in the shell 40. Each cavity 44 is shaped to receive a specific one of the patient's teeth 42. As indicated in FIG. 4, the cavities 44 receive respective ones of the patient's teeth 42 through the opening 50.

With continued reference to FIG. 4, to conform to the patient's teeth 42, the shell 40 has wall portions that are configured to conform to exposed surfaces of the patient's teeth 42. By way of example, the wall portions may be defined by an occlusal portion 52, a labial portion 54, and a lingual portion 56. The portions 52, 54, 56 are shown with respect to an exemplary cavity 60. The edge 46 defines a gingival portion of the shell 40. The portions 52, 54, 56 of each cavity 44 generally conform to the corresponding portions of a respective one of the patient's teeth 42 with the edge 46 corresponding to the gingival margin for the specific tooth. The shell 40 may also include distal portions 62 that encircle the cavities 44 that receive the rear-most molar teeth. While terms labial, mesial, distal, occlusal, and gingival are used in the description of the figures, they are referenced only to differentiate one direction from another and are not limiting. Further, the term “wall” in any of the labial wall, mesial wall, distal wall, occlusal wall, and gingival wall is not limited to a flat surface, i.e., a plane oriented or facing in a particular direction. For example, any single one or all the walls may be curved (i.e., having no flat regions) and/or be multifaceted (i.e., having many flats).

In the non-limiting exemplary embodiment, the aligner 12 includes an integral structure 64, such as an integral hook in the shell 40. The integral hook 64 has bubble-like configuration and forms a cavity separate from the adjacent cavity 44. The integral hook 64 is formed in the aligner 12 by placement of a mold feature 66 on the mold 14 (FIG. 1). While the integral hook 64 is shown on a labial portion 54 of the shell 40, the orientation and location of the integral hook 64 is not limited thereto. For example, an integral hook may be formed on a lingual portion 56 defining any one of cavities 44. The location of the integral hook 64 is determined by the computer model. The mold 14 having the mold feature 66 (FIG. 1) at that location is then manufactured.

In one embodiment shown in FIG. 4, the aligner 12 in conjunction with an attachment 70 on the patient's tooth 42 forms a system 72 for orthodontic treatment and may be utilized with an elastic band or other elastic member, not shown, for application of tooth-moving forces not possible with the aligner alone. Exemplary aligners with integral hooks are disclosed in commonly-owned U.S. application Ser. No. 18/048,666, filed on Oct. 21, 202, which is incorporated by reference herein in its entirety. During orthodontic treatment, the dental aligner 12 is selectively positionable over the patient's teeth 42. The integral hook 64 receives the attachment 70. The shell 40 may fit tightly over the teeth 42 at least partly due to slight differences in the position of one or more of the cavities 44 relative to the position of the corresponding tooth 42. This misalignment may be intentional according to a treatment plan developed for the patient. As a result of these misalignments, the aligner 12 may elastically deform while positioned over the patient's teeth 42. The elastic deformation may be observable as a measurable amount of bulk strain or localized strain in the shell 40. The strain in the shell 40 produces pressure on the teeth as the shell 40 attempts to return to an un-strained condition or a reduced strain configuration. The forcible contact with the aligner 12 may move the patient's teeth toward a predetermined position according to a patient's treatment plan. In that regard, the integral hook 64 may be misaligned with the attachment 70 and so the integral hook 64 may forcibly engage the attachment 70 depending on the intended movement of the tooth 42.

In one embodiment of the invention, the system 72 may include a set of aligners (not shown) with one or more dental aligners 12 and one or more attachments 70. During orthodontic treatment, each of the aligners in the set may differ slightly so that they each provide slightly different movement of the teeth. Each aligner 12 may include one or more of the integral hooks 64 to cooperate with a corresponding attachment 70. The location of the one or more integral hooks 64 and attachments 70 may change for each aligner 12. In other words, the set of aligners may correspond to a set of attachments with the number and location of the attachments changing in individual ones of the set of aligners. During treatment, the attachments may be removed from one tooth and new attachments added to another tooth. The individual dental aligners are utilized in a predetermined sequence to complete orthodontic treatment. Accordingly, each aligner 12 in the set of aligners may move one or more teeth a prescribed amount. Cumulatively, these individual amounts may result in complete treatment of the patient's malocclusion.

As described above, prior to the aligner 12 (e.g., FIG. 4) being usable for treatment, the aligner 12 (or the deformed worksheet 30) must be separated from the mold 14. One arrangement of the aligner 12 coupled to the mold 14 and prior to separation is shown in FIG. 3. Applicant discovered that mold materials that change properties can facilitate separation of the aligner 12 from the mold 14 after deforming the worksheet 16 around the mold 14. As an example, a mold material that is capable of swelling when exposed to a fluid can improve the ease of separation by reducing the force required to separate the aligner 12 from the mold 14. From a different perspective, improving separation may include reducing the time required separate the aligner 12 from the mold 14.

The concept of swelling is illustrated with respect to an expansion in volume of a cube 80 of an exemplary material in FIG. 5 when exposed to a fluid 82. In the exemplary embodiment, a cube 80 of mold material is submerged in the fluid 82. Submersion activates the mold material and so initiates a change in the properties of the mold material. By way of example, following exposure to the fluid 82, the cube 80 begins to change shape. One exemplary shape change is swelling, during which the cube 80 increases in volume. That is, before exposure, the cube 80 has volume V1. Sometime after submersion in the fluid 82, the cube 80 has a volume V2. The swelled volume V2 is greater than the initial volume V1. The volume expansion of the cube 80 of the mold material may not be reversible.

While in the exemplary embodiment, activation includes submerging the cube 80 in the fluid 82, embodiments of the invention are not limited to submersion. For example, the mold material may be activated by spraying the fluid 82 on the mold material. Thus, mere contact of an exposed surface of the mold material may activate the mold material to, for example, cause swelling. Further, in the exemplary embodiment, the fluid 82 is shown as a liquid, which is held in a container 84, such that the cubes 80 are submerged in a liquid bath. Embodiments of the invention are not limited to liquids. More particularly, the fluid 82 may be a gas in which case the fluid bath may be formed in a sealable container and the gas pumped into the container. So, where the fluid 82 is water (i.e., H₂O) or at least is a water-containing solution, the water or water-containing solution may be in a liquid phase and/or a gas phase.

### Example 1

With continued reference to FIG. 5, to measure the rate of swelling, volume measurements of a cube of mold material were made at time intervals following submersion. By way of example only, and not limitation, the mold material tested was Perfect Cast WS1 Water Soluble for SLA, DLP & LCD Printers from 3Dresyns. Three 11 mm by 11 mm by 11 mm cubes of 3Dresyns material were 3D printed under standard machine parameters on an ELEGOO Mars 3 Pro 4K 6.66″ MONO LCD MSLA Resin 3D Printer. The Chitubox parameters were as follows: Resolution X: 4098 px; Y: 2560 px; Machine Type Mirror: LCD_mirror; Size X: 143.430 mm; Size Y: 89.6 mm; Size Z: 175 mm; Exposure Time 30 s; Lift Distance 5 mm; Lift Speed 65 mm/min; Bottom Exposure Time 80 s; Layer Height 0.05 mm; and Retract Speed 150 mm/min.

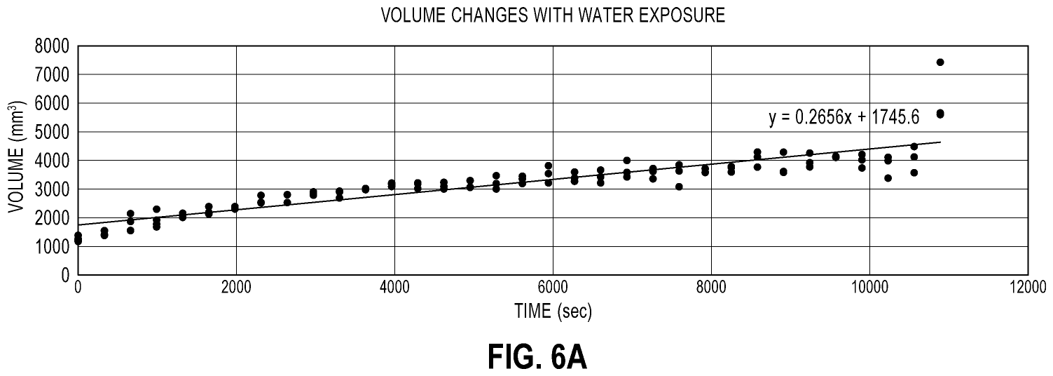

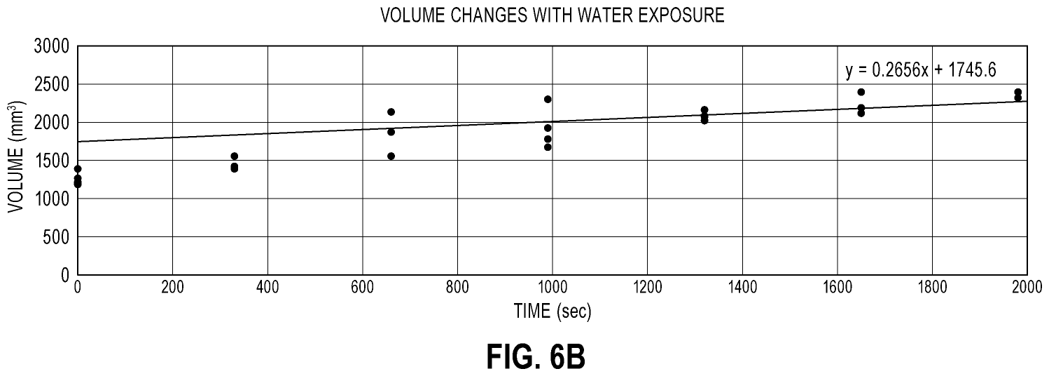

Each cube was submerged in 80° C. water (submersion is shown, for example, in FIG. 5). At predetermined time intervals of 5 minutes 30 seconds, one side of each cube was measured. The volume of each cube was calculated from the measured dimensional data. Calculated volume is plotted against time in FIG. 6A. An enlarged view of a selected range of FIG. 6A is shown in FIG. 6B. From the data, a swelling rate of at least 0.96 cc/hr was calculated by least squares analysis of the data plotted in FIG. 6A. It is noted that the mold material is dissolvable in water. This is illustrated by the rapid increase in the volume at about 11,000 seconds in FIG. 6A. The exemplary material therefore swells and then eventually dissolves when submerged in water.

In particular, with reference to FIG. 6B, in an exemplary embodiment, the mold material swells by at least 20% after submersion in water for 5 minutes and 30 seconds. For example, from FIG. 6B, with an initial calculated volume of 1,250 mm³, after submersion, the cube has a calculated volume of 1,500 mm³. Not being bound by theory, swelling (i.e., volume expansion) may be due to absorption of the fluid by the mold material. Property changes were not limited to swelling, for example, in addition to the mold material softened and was pliable and elastic when removed from the water.

### Example 2

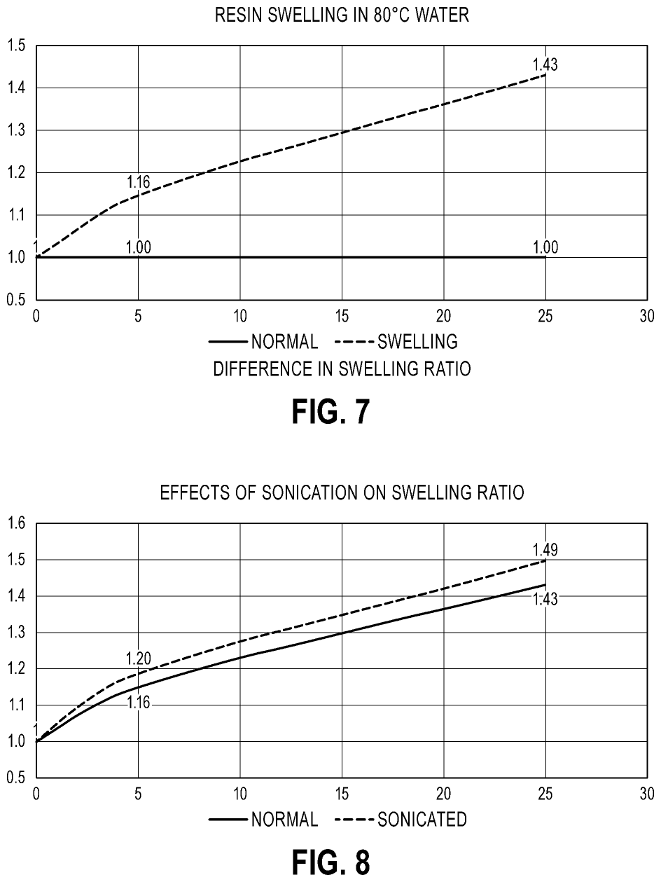

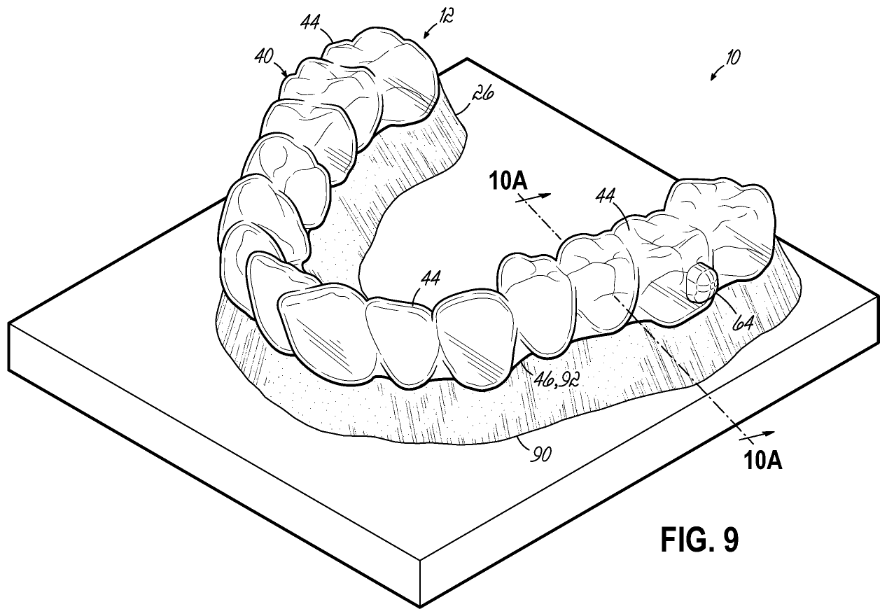

Additional testing was completed and is shown in FIGS. 7 and 8. For the data in FIG. 7, cubes of the same material as is described above in Example 1 with respect to FIG. 6A were placed in water at 80° C. At predetermined time intervals, each of the cubes was removed from the water and weighed. Weight data was plotted versus time in FIG. 7. For comparison to swell rate as measured by a volume increase, after submersion for 5 minutes and 30 seconds, a 16% weight gain of the mold material was measured. Calculations show that the material can swell 1,000% relative to its starting volume in about 24 hours. It is believed, however, that swelling for mold removal is a mold volume that is 1.3 times the original mold volume.

### Example 3

With reference to FIG. 8, cubes of the same material described above in Example 2 with respect to FIG. 7 were printed. The influence of ultrasound application in the water while the cubes were submerged in 80° C. water was investigated for 20 kHz. As shown, the weight gain of the cubes increased by about 5% over the weight gain of the cubes without application of ultrasound.

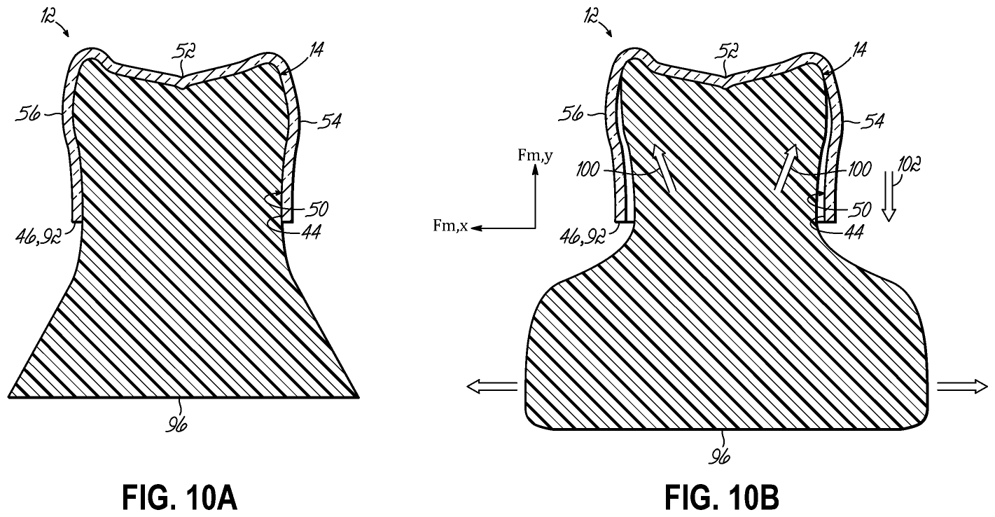

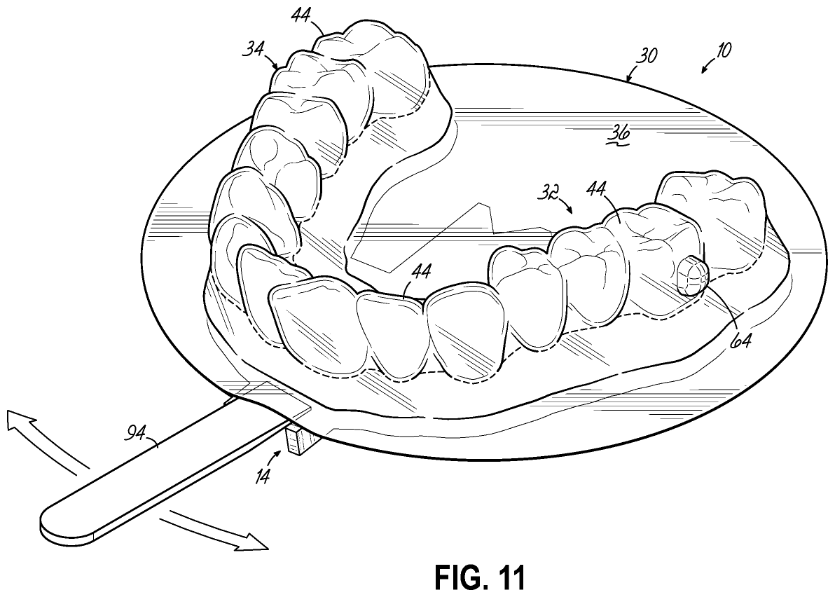

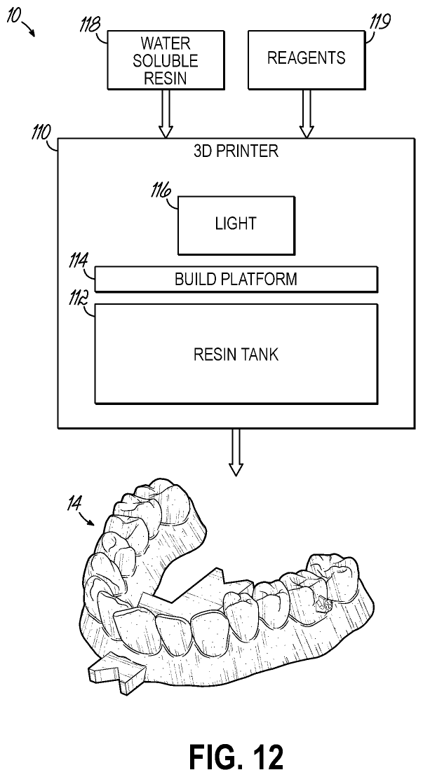

In one embodiment, with reference now to FIGS. 9, 10A, and 10B, swelling of the mold 14 and separation of the aligner 12 is conceptually shown. FIGS. 10A and 10B are cross-sections that correspond to an aligner cut along the line 92 in FIG. 9. During manufacturing, an aligner is typically cut at or near line 92. This cut location generally follows the gingival margin 28 of the mold 14 and may correspond to edge 46. Cut line 92 may be referred to herein as a CNC cut and is described in more detail below.

When the mold 14 and the aligner 12 are simultaneously exposed to fluid, the material of the mold 14 is activated. In the exemplary embodiment, the mold 14 swells. While not being bound by theory, generally, volume expansion (i.e., swelling) of at least a portion of the mold 14 is believed to generate forces on the aligner 12. The forces generated may cause separation of the mold 14 from the aligner 12 or may at least aid that separation. In FIG. 9, the aligner 12 is shown following deformation of the worksheet over the mold 14 and following machining along line 92 and prior to separation of the deformed worksheet.

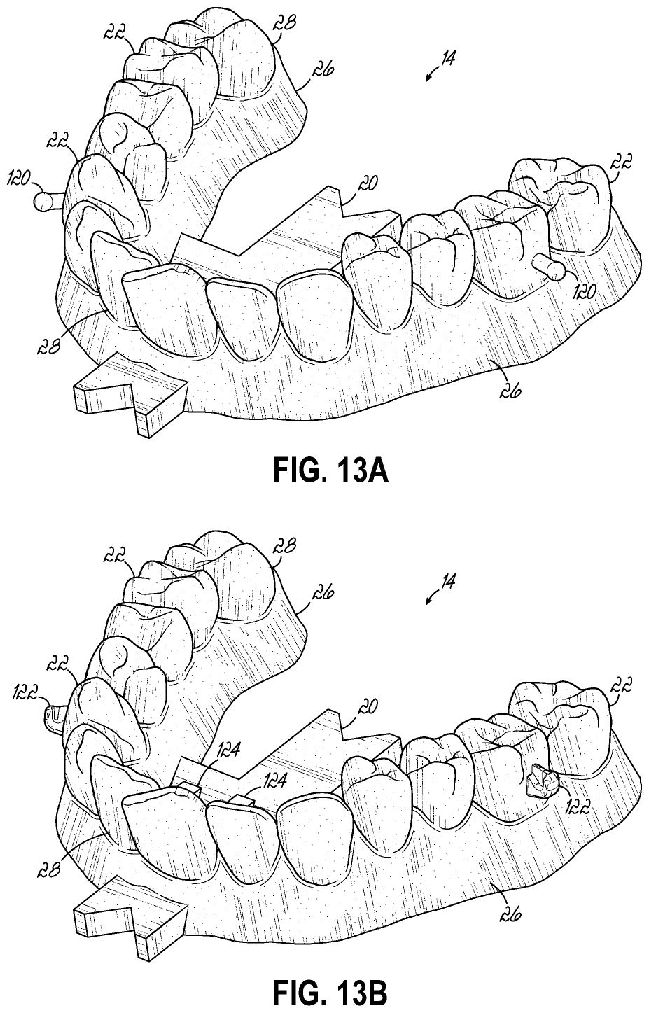

In the configuration of the cut line 92 shown in FIG. 9, without activation of the mold material, the aligner 12 may be manually removed from the mold 14. An example of separation without activation is shown in FIG. 11, in which a tool 94 is inserted between the aligner 12 and the mold 14. By leveraging the tool 94, the aligner 12 may be separated from the mold 14. Use of the tool 94 thereby provides a force greater than the threshold separation force for separation of the aligner 12 from the mold 14.

According to embodiments of the invention, and with reference to FIGS. 9, and 10B, following activation of the material of the mold 14, swelling of the mold 14 is believed to generate a force tending to separate the aligner 12 from the mold 14. As an example, swelling of the mold 14 may produce a force greater than the threshold separation force and so is sufficient to separate the aligner 12 from the mold 14. In this way, the force from swelling may eliminate the need for the tool 94 (FIG. 11). In one embodiment in which the mold and deformed worksheet or aligner are submerged, the buoyancy of the aligner 12 can be greater than the buoyancy of the swollen mold 14, causing the aligner 12 to float off of the swollen mold 14. This is referred to as self-separation and is shown in FIG. 17.

When activated, such as by submersion of the mold 14 and the aligner 12 in a fluid (submersion is not shown in FIG. 10B), an exposed portion 96 of the mold 14 begins to swell. Because the entirety of the mold 14 is not exposed to the fluid, swelling of the mold 14 may begin only at an exposed surface/region 96 of the mold 14. The swelling gradually progresses toward the occlusal portion 52 of the aligner 12 according to the arrows 100. The fluid may penetrate through the opening 50 and between the mold 14 and the aligner 12.

With time, the proportion of the mold 14 that expands may gradually increase as the fluid migrates through the mold material and/or along an interface between the mold 14 and the aligner 12. The fluid may eventually be distributed throughout the entire volume of the mold 14 so that the entirety of the mold 14 begins to swell. Nevertheless, a gradient in the swelling may initially exist following submersion. An initial volume of the mold material at the exposed surface/region 96 swells first, while portions of the mold material adjacent the occlusal portion 52 of the shell 40 remain unchanged (no swelling), as is schematically illustrated. Moreover, the rate of swelling of the entire mold 14 may be controlled by controlling the surface area of the mold 14 exposed to the fluid. As the surface area of the mold 14 exposed to the fluid increases, the rate of swelling may also increase.

Further, although FIG. 10B is a cross-section of the mold 14 and deformed worksheet/aligner 12 and thus illustrate two dimensions, swelling of the mold 14 occurs in three dimensions. For example, at the exposed surface 96 in FIG. 10B, the mold 14 may expand out of the aligner 12 (shown downwardly according to arrow 102). A majority of the difficulty in removing the aligner 12 from the mold 14 is due to undercuts (not shown in FIG. 10B), that is, parts of the mold 14 that create an interference fit between portions of the aligner 12 and the mold 14 in the direction of removal of the aligner 12 from the mold 14. For example, the mold feature 66 in FIG. 1 creates an undercut. These undercut configurations often occur at inter-proximal areas in a crowding condition or in areas under a large attachment that is to be used on a tooth. By contrast, if the aligner lacks undercuts, the aligner 12 is easy to remove from the mold 14. In such cases, as the mold 14 swells, the mold 14 becomes softer and at the same time expands in all directions. Expansion pushes the aligner 12 away from the mold 14 in all directions. When expansion reaches a point where the aligner 12 is no longer capable of containing the expanding mold 14, the aligner 12 flexes, deforms and may eventually self-escape from the mold 14.

With further regard to forces on the aligner 12, at the exposed region 96 of the mold 14 in FIG. 10B, the mold 14 may also swell laterally in the plane (shown by arrows to the right and to the left in FIG. 10B) as well as perpendicularly to the plane of the figure. In each of these lateral directions, swelling of the material is resisted by the aligner 12. The mold material may push against the aligner 12 and may cause elastic deformation of the aligner 12. Swelling is believed to produce a net force on the aligner 12 tending to push the aligner 12 in a direction out of the mold 14. As the mold 14 swells in accordance with FIGS. 6A and 6B, for example, the net force may increase until a threshold level of force is achieved at which the aligner 12 spontaneously separates from the mold 14. Even if the aligner 12 is not removed from the mold 14, the net force reduces the magnitude of an external force application, such as with the tool 94 described above and shown in FIG. 11. With a swollen mold 14, the aligner 12 is easier to remove.

By way of example only, force development is conceptually shown in FIG. 10B. In FIG. 10B, forces on the aligner 12 are due to swelling of the mold 14. A force component on the aligner 12 tending to push the aligner 12 off the mold 14 is labeled “Fm, y,” and a force component in a lateral direction (i.e., perpendicular to Fm, y in the plane of FIG. 10B) is labeled “Fm, x.” The force components may be the result of swelling of the mold 14 in conjunction with an interfacial geometry between the mold 14 and the aligner 12. Generally, cross-sections of the aligner 12 may have a generally wedge-shaped configuration from the opening 50 toward the occlusal portion 52 of the aligner 12. The generally wedge-shaped configuration includes a cross-sectional dimension across the opening 50 that is generally greater than the remaining cross-sectional dimensions of the mold 14. That is, the interface between the mold 14 and the aligner 12 is widest at the opening 50 of the aligner 12. With the wedge-shaped configuration, a force on the aligner 12 due to swelling of the mold 14 may broken down into a y-component force, i.e., Fm, y and an x-component force, i.e., Fm, x. Although not shown in FIG. 10B, there is believed to be a force generally perpendicular to the plane of the figure. While cross-sections of the aligner 12 and mold 14 are shown, force development is believed to occur at all locations at which the mold 14 swells. Once a sum of all y-component forces, i.e., ΣFm, y, reaches a magnitude slightly greater than the threshold retention force between the mold 14 and the aligner 12, the aligner 12 is spontaneously removed from the mold 14. From a different perspective, the mold 14 may slide out of the aligner 12 once a certain volume expansion is reach. In that regard, swelling of mold 14 may not be instantaneous. The time needed for the mold to swell sufficiently to cause separation depends on factors including, but not limited to: fluid temperature, mold material, and mold geometry, to name a few.

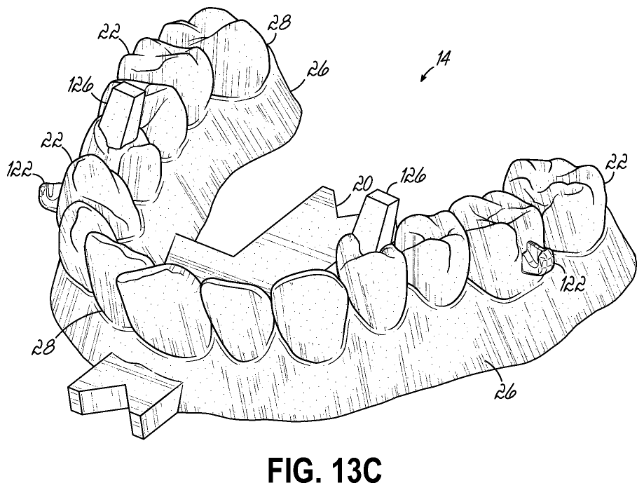

Referring now to FIG. 12, one embodiment of the system 10 for manufacturing an orthodontic application is shown. In the exemplary embodiment, a 3D printer 110, such as an SLA or LCD printer, may include a resin tank 112 positioned below a build platform 114 and a light 116. The build platform 114 is submergible in the resin tank 112 and into a liquid resin. The light 116 can cure the resin of the resin tank 112, layer-by-layer, onto the build platform 114 until the mold 14 is complete. A resin 118 can be mixed with other reagents 119 to form the resin of the resin tank 112 that has sufficient resolution for printing the mold 14. In some arrangements, the resolution of the mold 14 can be validated by 3D scan overlays. A non-limiting, illustrative formulation of a resin mixture that produces the mold 14 having sufficient resolution and swelling characteristics is Perfect Cast WS1 Water Soluble for SLA, DLP & LCD Printers from 3Dresyns available from 3DResyns.

While there are many advantages to systems and methods disclosed herein, including self-separation and reduced time for separation of the mold 14 from the aligner 12, as described above, additional advantages include application of unique integral structures and combinations of integral structures on the aligner 12. The application of these integral structures and combinations of structures was not possible due to problems with separation of the aligner from the mold. For example, according to some embodiments, molds may be manufactured with structural features that project outwardly from portions of the model teeth portion of the mold. These non-tooth structural features may enhance orthodontic treatment efficiency when transferred to an aligner via deforming the worksheet. However, the non-tooth structural features singly or in combination may form an undercut relationship between the deformed worksheet and the mold. Absent assistance from the mold with separation from the aligner, this reentrant relationship prevents their separation. With separation assistance from the mold material itself, the undercut features do not prevent separation of the mold from the aligner or cause a significant manufacturing delay. Advantageously, mold materials according to embodiments of the invention permit manufacturing integral features in aligners, including features formed by undercut structural features on the mold.

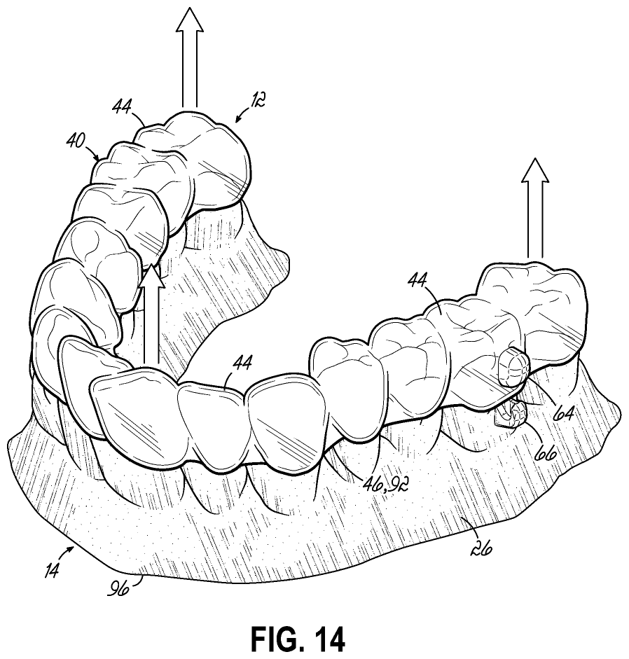

In accordance with embodiments of the invention, molds that assist with removing the deformed worksheet make individual integral structures and combinations of those integral structures practical. For example, with reference now to FIGS. 4, 13A, 13B, and 13C, according to one aspect of the invention, the mold 14 is manufactured. As an example, the system 10 shown in FIG. 12 may be utilized to manufacture the mold 14. To that end, a clinician may opt to design the aligner 12 with the integral hook 64 (FIG. 4). During manufacturing of the mold 14, a correspondence mold feature 66 (FIG. 1) is built into the mold 14. Per FIG. 4, the mold feature 66 is configured to form the integral hook 64 in the aligner 12 during deforming of the worksheet 16 over the mold 14. Thus, the mold 14 may be designed and built with features that produce different non-tooth structures that project outwardly from the projections 22, which represent model teeth. While the mold feature 66 in FIG. 1 is one exemplary feature, there are other features buildable into the mold 14 according to embodiments of the invention. For example, although one mold feature 66 is described and shown with respect to one mold 14 (see, e.g., FIG. 1), multiple mold features 66 may be formed on a single mold or on multiple molds according to any single orthodontic treatment plan. Thus, the clinician may develop a treatment plan utilizing one or more mold features 66 to form corresponding integral hooks 64 that change in orientation and in location from mold to mold and thus from aligner to aligner during treatment. Embodiments of the invention are not limited to a single mold with a single structure as is shown in the figures.

In addition, or alternatively, non-tooth conforming structural features, such as bite ramps and tabs configured to form posts for use with molar advancement device are buildable in molds according to embodiments of the invention. Referring to FIG. 13A, by way of example and not limitation, in addition to the feature 66 or as an alternative, the clinician may design an integral tab 120 for one or more cavities 44. The integral tab 120 may be useful for attachment of a Herbst style appliance, including, for example, AdvanSync available from Ormco Corporation, to the corresponding aligner. As shown in FIG. 13A, the integral tab 120 may be built into the mold 14 at two locations.

By way of further example, in FIG. 13B, multiple non-tooth features 122 may be built into the mold 14. As shown, the orientation of each feature 122 may vary. Embodiments of the invention are not limited to the orientation shown. In combination with the non-tooth features 122, such as integral hooks, one or more additional non-tooth features 124 may include bite bumper features. As shown, the bite bumper features 124 may be built into an inner surface of the projections 22 with the hook features 122 being placed on an opposite, exterior surface of the projections 22. Thus, mold features may be built into opposing surfaces of the projections. These surfaces generally represent the lingual and labial surfaces of the patient's teeth.

With reference to FIG. 13C, in one embodiment, the mold 14 may include a plurality of posts 126, which are also non-tooth features, that project outwardly from projections 22 in a lingual-occlusal direction and in a labial-occlusal direction. These may be referred to as occlusal structures for bite correction. As shown, the posts 126 may extend outwardly above the projections 22 and define an occlusal surface of the mold 14.

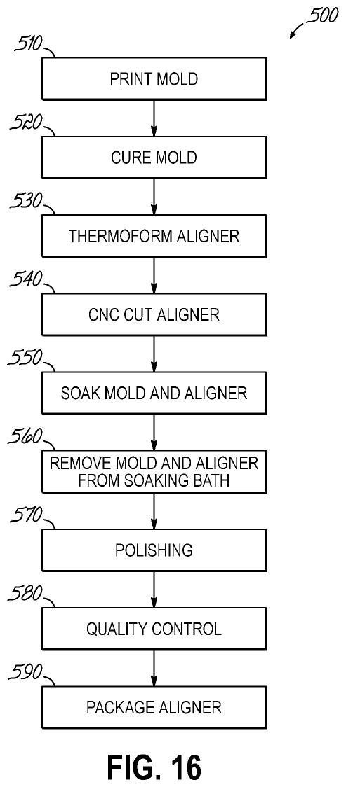

In one embodiment and with reference to FIG. 16, an exemplary method manufacturing 500 an aligner is shown. The method 500 may include a print step 510 in which the mold 14 is printed with an SLA or LCD printer 110 (FIG. 12) using a print formulation that includes the resin 118, which may be water soluble following printing. The method 500 can include a cure step 520 in which the mold 14 can be cured by a light or chemical treatment. The method 500 can include a thermoforming step 530 in which a worksheet 16 of material is thermoformed over the mold 14 to form the aligner 12, shown in FIGS. 1 and 2, for example. The method 500 can include a cutting step 540 in which the aligner 12 is cut away from the deformed worksheet 30 that was thermoformed over the mold 14. See, for example, FIGS. 2 and 3. The method 500 can include an exposing step 550 in which the mold 14 and aligner 12/deformed worksheet 30 are activated, such as by submerging them simultaneously in a fluid bath. This is shown as a soaking step in FIG. 16. A result of which the material of the mold 14 changes properties. In the exemplary embodiment, the mold 14 and deformed worksheet 30 are submerged or placed within a fluid bath, such as the water bath shown in FIG. 5. The method 500 can include a removal step 560. In an exemplary embodiment, the aligner 12 and the mold 14 are removed from the warm water bath after the mold 14 has swollen and become separated from the aligner 12. The method 500 can include a polishing step 570 in which the aligner 12 is polished, as necessary. The method 500 can include a quality control step 580 in which the quality of the aligner 12 is evaluated. The method 500 can include a packaging step 590 in which the aligner 12 is packaged for shipment. In some arrangements, the method 500 can include only a subset of the aforementioned steps. In some variants, the method 500 can include addition steps that are performed between or in addition to the aforementioned steps. For example, there may be a disposal step in which the mold 14 recycle or disposed of. In some arrangements, the method 500 can include one or more of the aforementioned steps being performed in an order other than in the order depicted in FIG. 16.

### Other Variations and Terminology

While certain embodiments have been described, these embodiments have been presented by way of example only, and are not intended to limit the scope of protection. Indeed, the methods and systems described herein may be embodied in a variety of other forms. It will be understood by those skilled in the art that the present disclosure extends beyond the specifically disclosed embodiments to other alternative embodiments or uses and obvious modifications and equivalents thereof, including embodiments which do not provide all the features and advantages set forth herein. Furthermore, various omissions, substitutions, and changes in the form of the methods and systems described herein may be made. Those skilled in the art will appreciate that in some embodiments, the actual steps taken in the processes illustrated or disclosed may differ from those shown in the figures. Depending on the embodiment, certain of the steps described above may be removed and/or others may be added. Accordingly, the scope of the present disclosure is not intended to be limited by the specific disclosures of preferred embodiments herein and may be defined by claims as presented herein or as presented in the future. The language of the claims is to be interpreted broadly based on the language employed in the claims and not limited to the examples described in the patent specification of during prosecution of the application, which examples are to be construed as non-exclusive.

Features, materials, characteristics, or groups described in conjunction with a particular aspect, embodiment, or example are to be understood to be applicable to any other aspect, embodiment, or example described herein unless incompatible therewith. All the features disclosed in this specification (including any accompanying claims, abstract, and drawings), or all the steps of any method so disclosed, may be combined in any combination, except combinations where at least some of such features or steps are mutually exclusive. The protection extends to any novel one, or any novel combination, of the features disclosed in this specification (including any accompanying claims, abstract, and drawings), or to any novel one, or any novel combination, of the steps of any method or process so disclosed.

Conditional language, such as “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all the elements in the list. Further, the term “each,” as used herein, in addition to having its ordinary meaning, can mean any subset of a set of elements to which the term “each” is applied.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of the stated amount. As another example, the terms “generally parallel” and “substantially parallel” may refer to a value, amount, or characteristic that departs from exactly parallel by less than 15 degrees.

What is claimed is:

1. A method of manufacturing an orthodontic appliance, the method comprising:
providing a mold including one or more projections representing a patient's teeth and comprising a resin;
deforming a worksheet over the one or more projections, wherein the deformed worksheet includes the orthodontic appliance;
exposing the resin to a fluid whereby at least one material property of the resin changes; and
during or after a change in the at least one material property, removing the orthodontic appliance from the mold.

2. The method of claim 1 wherein during exposing, the change in the at least one material property of the resin includes a change in a volume of the mold.

3. The method of claim 2 wherein the change in the volume is from a first volume of the mold during deforming of the worksheet to a second volume after exposing the resin to the fluid.

4. The method of claim 3 wherein the second volume is greater than the first volume.

5. The method of claim 3 wherein the second volume is at least 20% greater than the first volume.

6. The method of claim 1 wherein exposing the resin to the fluid includes submerging the mold and the deformed worksheet in the fluid.

7. The method of claim 1 wherein exposing the resin to the fluid includes simultaneously exposing the mold with at least a portion of the deformed worksheet to the fluid.

8. The method of claim 1 wherein the fluid is water.

9. The method of claim 8 wherein the water is liquid.

10. The method of claim 1 wherein the fluid is liquid.

11. The method of claim 1 wherein the fluid is liquid water and the change in the material property of the resin includes a change in a volume of the mold.

12. The method of claim 11 wherein exposing the resin to the liquid water includes submerging the mold in the liquid water.

13. The method of claim 1 wherein the fluid is liquid water and the change in the material property of the resin includes a change in a weight of the mold from a first weight prior to deforming to a second weight after exposing, the second weight being greater than the first weight.

14. The method of claim 1 wherein providing the mold includes printing the mold.

15. The method of claim 1 wherein during removing, the deformed worksheet self-separates from the mold.

16. An orthodontic appliance made according to the method of claim 1.

17. The orthodontic appliance of claim 16 wherein the orthodontic appliance is a dental aligner, and the dental aligner includes a hollow shell having at least one cavity configured to receive at least one of a patient's teeth.

18. A system for manufacturing an orthodontic appliance, comprising:
a mold comprising:
a base; and
one or more projections representing one or more of a patient's teeth extending from the base,
wherein the base and the one or more projections comprise a resin configured to react with a fluid whereby at least one material property of the mold changes.

19. The system of claim 18 wherein the resin is configured to react with water.

20. The system of claim 19 wherein the at least one material property is the volume of the mold.

21. The system of claim 20 wherein the volume of the mold is configured to increase by at least 20%.

22. The system of claim 18 wherein the resin is configured to swell at a rate of at least 0.96 cc per hour when exposed to the fluid.

23. The system of claim 18 further comprising:
a fluid bath configured to receive the mold.

24. The system of claim 23 wherein the fluid bath is a water bath.

25. The system of claim 23 further comprising:
a printer configured to transform one or more precursors into the mold comprising the resin.
